(19) United States
(12) Patent Application Publication
(10) Pub. No.: US 2002/0198954 A1
(43) Pub. Date: Dec. 26, 2002

(54) Information storage method, digital data processing method and apparatus

(76) Inventors: Tetsuo Okamoto, Ebina-shi (JP); Yoshinori Matsuno, Ebina-shi (JP); Hirotake Kudo, Ebina-shi (JP); Manabu Ushikubo, Ebina-shi (JP)

Correspondence Address: J.C. Patents, Inc., Suite 250, 4 Venture, Irvine, CA, 92618, US

(21) Appl. No.: 10/090,591

(22) Filed: Feb. 27, 2002

(30) Foreign Application Priority Data
Jun. 20, 2001 (JP) 2001-187406

(51) Int. Cl. G06F 15/16

(52) U.S. Cl. 709/213; 709/245

(57) ABSTRACT

An information storage method, digital data processing method and apparatus so that a user can conveniently and at low-cost deal with an image data. A data input/output device 85 reads an original and then transmits its image data to a data storage device 83 (data transmission T1). The data storage device 83 receives the image data and stores it in a memory 22J. The data storage device 83 replies with a storage location to the data input/output device 85 (data transmission T2). The data input/output device 85 prints the storage location. The user can obtain a printout 90 on which the storage location of the image data read at the data input/output device 85 is printed. The image data can then be acquired at a user computer set at a different place (data transmission T3, T4).

### CROSS-REFERENCE TO RELATED APPLICATION

This application claims the priority benefit of Japanese application serial no. 2001-187406, filed Jun. 20, 2001.

### BACKGROUND OF THE INVENTION

1. Field of the Invention

This invention relates in general to an information storage method, a digital data processing method and apparatus. More specifically, the invention relates to an information storage method for temporarily storing images read by an input device such as a scanning device, a digital data processing method and apparatus.

2. Description of Related Art

Recently, as semiconductor technology and other manufacturing technologies make great progress, the personal computer and its peripheral devices have become more high-speed and multi-functional. Therefore, users possessing a high-speed and multi-functional personal computer have increased. When such a computer is used, various complicated processes that were conventionally dependent on professionals are now be easily handled by the users. Accordingly, it is preferred that the user should in advance prepare the personal computer and peripheral devices required for on demand processes.

For example, a personal computer (PC), serving as an information terminal, is connected to the network, and therefore various information can be sent or received. Recently, the Internet is well known as a network that is user friendly. Therefore, it is possible to easily transmit and receive information only by preparing a PC including a communication device. Namely, a bi-directional transmission of the information becomes possible.

Although a high-performance and multi-functional PC can be easily obtained, but considering the usage, expense and efficiency, it is still very difficult for the user to prepare all peripheral devices for achieving the user's processes on demand. For example, the user is rarely called on to prepare a peripheral device that is seldom used and high-cost.

For example, recently the information of the transmitted data has increased greatly. The images (image data), for example the Home Page, handled by the PC are also increasing. The user uses the image data so that the capability of the information transmission increases.

However, the information of the image data increases according to increase of its resolution. Therefore, in order to use plural image data items, a memory with a large capacity is demanded. In addition, in order to obtain the image data, an image read device, such as a scanner, is required. As a result, it is very difficult for the generation of the image data and its use to be simply achieved by the user.

### SUMMARY OF THE INVENTION

Therefore, in consideration of the above facts, the invention provides an information storage method, a digital data processing method and apparatus that the user can conveniently and at low-cost use to deal with image data.

The invention provides an information storage method, including the steps of: receiving digital data input from an input device through a communication line; storing the received digital data; and transmitting access information for accessing a storage location of the stored digital data and a print instruction for printing the access information to an external device having a print function through the communication line.

The invention further provides an information storage method, including the steps of: receiving digital data input from an input device through a communication line; storing the received digital data; and transmitting access information for accessing a storage location of the stored digital data and distinguishing information for identifying the digital data to an external device having a print function through the communication line.

The invention further provides an information storage method, including the steps of: receiving digital data input from an input device through a communication line; storing the received digital data; and transmitting access information for accessing a storage location of the stored digital data and advertising information to an external device having a print function through the communication line.

The access information can show the storage location where the digital data is stored. The access information can be also identification information for referencing the stored digital data.

The access information is included in each of plural images on a single page. The access information can also be included in each of plural images on respective plural pages. The plural images are defined by image data to be transmitted. In addition, the access information and the distinguishing information are included in a composed image defined by image data top be transmitted.

The digital data is image data and the distinguishing information is the image data that has been edited. The image data defines plural images on respective plural pages, and the edit of the image data is to make the image data define the plural images to be on a single page. In addition, the edit of the image data makes plural locations contain a same image. Plural locations in a single page can contain the same image. The same image can be included in plural locations on respective plural pages.

Furthermore, the digital data can be image data defining plural images on respective plural pages, and the distinguishing information can be an image on a predetermined page among the plural images on plural pages. The image on the predetermined page can be an image on the first or on the last page. Charge information of an expense concerning the information storage can be changed.

The invention further provides a digital data processing method, including the steps of: inputting digital data; transmitting the input digital data to an external device that stores the digital data through a communication line; and printing access information on a print medium, wherein the access information is used for accessing the digital data that is transmitted to and stored in the external device.

The access information can be received from the external device. The input digital data is image data and at least one portion of the digital data is stored. The stored digital data and the received access information are combined and printed on the print medium. The input digital data is image data, and the input image data is edited and then printed on the print medium. The received access information and an advertising information that is stored in advance or input from the external device are printed on the print medium.

The invention further provides an information storage apparatus, including a receiving device for receiving digital data input from an input device through a communication device; a storing device for storing the digital data received by the receiving device; and a transmitting device for transmitting access information for accessing a storage location that stores the digital data and a print instruction of the access information to an external device having a print function through the communication line.

The invention further provides an information storage apparatus, including: a receiving device for receiving digital data input from an input device through a communication line; a storing device for storing the received digital data; and a transmitting device for transmitting access information for accessing a storage location of the stored digital data and distinguishing information for identifying the digital data to an external device having a print function through the communication line.

The invention further provides an information storage apparatus, including: a receiving device for receiving digital data input from an input device through a communication line; a storing device for storing the received digital data; and a transmitting device for transmitting access information for accessing a storage location of the stored digital data and advertising information to an external device having a print function through the communication line.

The invention further provides a digital data processing apparatus, including: an inputting device for inputting digital data; a transmitting device for transmitting the digital data that is input from the inputting device to an external device that stores the digital data through a communication line; and a printing device for printing access information on a print medium. The access information is used for accessing the digital data that is transmitted to and stored in the external device. Additionally, the digital data processing apparatus further includes a receiving device for receiving the access information from the external device.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings in which:

FIG. 1 schematically shows a diagram of a computer network system according to the embodiments of the invention;

FIG. 2 schematically shows a block diagram of devices connected to the computer network system in FIG. 1;

FIG. 3 is a schematic flow chart for describing data output on the computer network system according to the embodiments of the invention;

FIG. 4 schematically depicts a print that the storage location (memory device) of the image data that the user requests to store is printed on a print medium;

FIG. 5 is a schematic flow chart showing the process executed by the data input/output device;

FIG. 6 is a schematic flow chart showing the process executed by the data storage device;

FIG. 7 is a schematic flow chart showing the process executed by the data acquisition device;

FIG. 8 schematically depicts a print that the plural storage locations (memory devices) of the image data that the user requests to store is printed on a print medium;

FIG. 9 schematically depicts a print that the storage location (home page) of the image data that the user requests to store is printed on a print medium; and

FIG. 10 schematically depicts a print that the storage location of the image data that the user requests to store, the advertising information and the coupon are printed on a print medium.

### DESCRIPTION OF THE PREFERRED EMBODIMENT

Before describing the preferred embodiments, an overview of the present invention will be shown as follows. In a server containing a storage device for storing the image data, the information storage method stores the image data input from an input device that possesses a print function and is connected to the communication line. The server receives a storage request of the image data input by the input device as well as device location information showing the location of the input device on the communication line. According to the received storage request, the image data is stored in the storage device and storage location information of the image data stored in the storage device is acquired. Then, completed information, which contains the storage location information and shows that the image data has been stored in the storage device, is printed on a print medium at the input device, by which the completed information is transmitted to the input device based upon the foregoing device location information.

The foregoing description is suitable for an information storage method that stores an image data through a communication line, such as the Internet. For example, in a server having a storage device for storing the image data, the information storage method stores the image data input from an input device that possesses a print function and is connected to the communication line. First, the server receives a storage request of the image data input by the input device as well as device location information. The input device is used for inputting the image data, and the image data can be directly input or obtained by scanning the image. The device location information is a URL (Uniform Resource Locator) or IP (Internet Protocol) address showing the location of the input device on the communication line. If referring to the device location information, the location on the communication line can be specified and therefore information can be received/transmitted. In addition, the input device is not only limited to a device that is directly connected to the network, such as the Internet, but also a device that can be connected to the network such as the Internet via a wired or wireless communication.

The server stores the image data to the storage device according to the received storage request. That is, the server receives the image data that has been requested to be stored, and then stores the image data to the storage device. When storing the image data, the server can get the location of the image data that is stored in the storage device. In other words, the server can acquire the storage location information of the image data that is stored in the storage device. The storage location information can be a directory or a location of the storage device that contains the image data. In addition, the storage location information that shows the location of the image data itself is preferred, but can also show a location that stores an instruction information for prompting the location of the image data itself. For example, a URL of a home page or an IP address of a FTP server can be used.

Furthermore, the server transmits the completed information to the input device. The completed information includes the storage location information and shows that the image data has been stored in the storage device. The completed information is then transmitted so that the completed information is printed on the print medium at the input device. When transmitting, the input device is specified according to the device location information, and then the completed information is transmitted to the input device. Accordingly, the completed information is printed at the input device. The storage location of the image data input by the user is printed on a printout. By referring to the printout, the user can get the storage location of the image data easily.

The printout is useful and effective when at a remote place the user wants to acquire the image data that the user requested to be stored. That is, when the user requests the image data stored to the storage device, a device for acquiring the image data is not limited to the input device. Therefore, referring to the printout, the image data can be easily acquired by connecting to the storage device described in the completed information through the communication line, such as the Internet.

Regarding the server that stores the image data in the storage device, identification information for permitting reference to the image data can be determined to add into the foregoing completed information, and then the identification information can be transmitted.

When the server stores the image data in the storage device, there is a possibility that the information showing capability of connecting to the storage device may be acquired by a third person. Therefore, the server determines the identification information for permitting reference to the image data stored in the storage device. When an identification input by a user is consistent with the predetermined identification information, reference to the image data is permitted. Additionally, referencing the image data is not only limited to the reference of the image. For example, commands such as updating or deleting can be performed. The user has to be informed of the identification information. Thus, the server adds the identification information to the completed information, which then will be transmitted to the user. Accordingly, the user can have an access authority that permits referencing the image data that the user has requested to be stored, and access from the third person can be blocked.

The foregoing information storage method can be easily achieved by each device of an information storage server as described below. In detail, the information storage server includes a storage device, and the storage device is connected to the communication line and is used for storing the image data input by the input device having a print function. The information storage server includes the following devices. A receiving device is used for receiving a storage request of the image data input by the input device as well as device location information showing a location of the input device on the communication line. A storage device is used for storing the image data in the storage device according to the received storage request. An acquisition device is used for acquiring the storage location information of the stored image data. A transmitting device is used for transmitting completed information to the input device where the completed information, which includes the storage location information and shows that the image data has been stored in the storage device, is printed on a print medium.

It is preferred to have a privacy policy for the information storage server to keep the image data from being acquired by a third person, which can be easily achieved by each device of an information storage server as described below. In detail, regarding the image data that is stored in the storage device, the information storage server further includes a setting device for determining identification information for permitting reference to the image data. The setting device adds the identification information to the foregoing completed information, which will be transmitted to the user.

The information storage method can be written as a program stored in a portable medium for executing the functions of the information storage method. Accordingly, the program stored in the medium can be executed by a computer, and any computer can execute the program easily. In detail, the storage medium stores an information storage program that is executed at the server containing the storage device for storing the image data, and is used to store the image data input by the input device that has a print function and is connected to the communication line. The storage request of the image data input by the input device is received as well as device location information showing a location of the input device on the communication line. According to the received storage request, the image data is stored in the storage device, and the storage location information to store the image data in the storage device is acquired. Then, the completed information is transmitted to the input device according to the device location information where the completed information, which includes the storage location information and shows that the image data has been stored in the storage device, can be printed on the print medium.

Additionally, the information storage method is used for storing the image data input by the input device that possesses a print function and is connected to the server having the storage device for storing the image data through the communication line. In order to request the storage of the image data to the server, the input device reads the image and transmits the image data through the communication line to the server. When the storage location information of the image data that is stored in the storage device according to the storage request is transmitted to the input device from the server, the storage location information is received by the input device and the storage content information containing the received storage location information can be printed on the print medium.

An information storage method is suitable for storing the image data input by the input device that possesses a print function and is connected to the server having the storage device for storing the image data through the communication line. For example, in order to request the storage of the image data to the server, the input device reads the image and transmits the image data of the read image through the communication line to the server. The server stores the image data input by the input device, and then transmits the storage location information of the image data that is stored in the storage device based on the storage request to the input device. When the storage location information of the image data is transmitted from the server, the input device receives the storage location information, and therefore prints the storage content information that includes the received storage location information on the print medium. That is, the input device possesses the print function, by which the storage content information that includes the storage location information corresponding to the storage request of the input image data is received and printed. Accordingly, data, which relates to the content of the image data such as the storage location information of the input image data, can be printed out to be confirmed by the user. Therefore, the user can refer to the printout, and can easily acquire the image data by connecting to the storage device according to the storage content information through a communication line such as the Internet.

In addition, when the storage content information is printed on the print medium, the storage location information and a portion of the read image can be printed as the storage content information on the print medium.

In order to confirm the image, to present the image itself is preferred. Therefore, it is preferred that the image is presented at the device that requests the storage when the image is read to store. The user can easily confirm the image by printing a portion of the read image on the print medium. However, the image printing is not limited to presenting the image data without any alterations. For example, in order to reduce the data capacity, it is possible to reduce the resolution as well as the image size.

When the storage content information is printed on the print medium, predetermined advertising information can also be printed on the print medium.

After printing, the print medium will be seen by the user. Therefore, the print medium can be a useful and effective medium for providing information. When the storage content information is printed on the print medium, useful information can be provided to the user because the advertising information is also printed on the print medium. The advertising information can be presented by using predetermined information, or selecting from plural predetermined information items. Additionally, the advertising information itself can be received from other devices. It is possible to select whether the advertising information is printed or not.

When the advertising information is printed, the charge information that is predetermined in connection with the storage of the image data can be changed.

Regarding the advertising information printed when the storage content information is printed, it gives a lot of advantages and benefits to the provider, but there is also a possibility that the advertising information becomes the user's burden. Accordingly, the charge information that is predetermined in connection with the storage of the image data can be changed. For example, when storing the image data is charged or getting the printout is charged, the charged expense can be changed, such as making a reduction. Therefore, the user's burden can be reduced and therefore storage of the image data can be accelerated.

As described in the following image reading device, the information storage method can be easily achieved by the function of each device. In detail, the image reading device includes a reading device, a transmitting device, a receiving device and a printing device. The reading device reads an image. The transmitting device transmits the image data read by the reading device through a communication line in order to request that the image data be stored in a storage server that includes a storage device for storing the image data. The receiving device receives storage location information when the storage location information of the image data that is stored in the storage device according to the storage request is transmitted from the storage server. Then, the printing device prints storage content information, which includes the storage location information received by the receiving device, on a print medium.

The inventor proposes a “multi-function machine” having a variety of output functions, such as a scan function, a copy function, a facsimile function and a print function, etc., as a print server to be set at public places (for example, stores). Accordingly, various information input/output services can be provided by one multi-function machine, and therefore the space for setting up the device can be minimized. Such a multi-function machine is suitable for the present invention. In other words, the reading of the image, making the storage request of the image data and the printing of the storage location of the image data can be achieved by only one single multi-function machine. Therefore, a user who doesn't have such multi-function machine of his/her own can easily and in a friendly manner utilize these services.

Because it is preferred that the image reading device can also present the image itself for confirming the image, it is desirable that the print device prints the storage location information and a portion of the read image, which serves as a storage content information, on the print medium.

In addition, because the printed print medium is effective and useful as an information providing medium, an advertising information storage device for storing the advertising information can be further included. The printing device can print the storage content information as well as the advertising information, by which useful information can be further provided to the user.

If the advertising information is printed together with the storage content information, the advertising information gives a lot of advantages and benefits to the provider. Therefore, a setting device for setting a charge information in connection with the storage of the image data is further included. Accordingly, it is preferred to change the charge information set by the setting device when the advertising information is printed by the printing device.

The information storage method can be written as a program and stored in a portable medium for executing the functions of the information storage method. Accordingly, the program stored in the medium can be executed by a computer, and any computer can execute the program easily. In detail, the storage medium stores an information storage program that is executed at the input device, and the information storage program is used for storing the image data input by the input device that has the print function and is connected to the server containing the storage device for storing the image data through the communication line. The information storage program is executed at the input device to read the image. In order to request to store the image data in the server, the read image data is transmitted through the communication line to the server. The storage location information of the image data stored in the storage device based upon the storage request is transmitted from the server, received, and then printed on the print medium.

A system that includes an information storage server and an image reading device is constructed, by which the user can store image data and can easily acquire the image data by referring to a printout having a storage location of the image data thereon. In detail, an information storage system is used for storing the image data input by the input device having a print function and is connected to the information storage server containing a storage device for storing the image data through a communication line. The information storage server has a receiving device, a storing device, an acquiring device and a transmitting device. The receiving device receives the image data input by the input device. The storing device is used for storing the image data to the storage device based upon the received storage request. The acquiring device is used for acquiring the storage location information of the stored image data. The transmitting device transmits the completed information to the input device according to the device location information, wherein the completed information that contains the storage location information and shows that image data has been stored in the storage device is printed on the print medium. In addition, the image reading device has a transmitting device, a receiving device and a printing device. In order to request to store the image data in the information storage server that contains the storage device for storing the image data, the transmitting device transmits the image data of the image read by the reading device to the information storage server through the communication line. The receiving device is used for receiving the storage location information when the storage location information of the image data that has been stored in the storage device based upon the storage request is transmitted from the information storage server. The printing device prints the storage content information that contains the storage location information received by the receiving device.

The embodiments of the invention are described in detail below with reference to the Figures. The invention is applied to a computer or a personal digital assistant (PDA) that is capable of being connected to a computer network system in a wireless or a wired communication.

<<First Embodiment>>

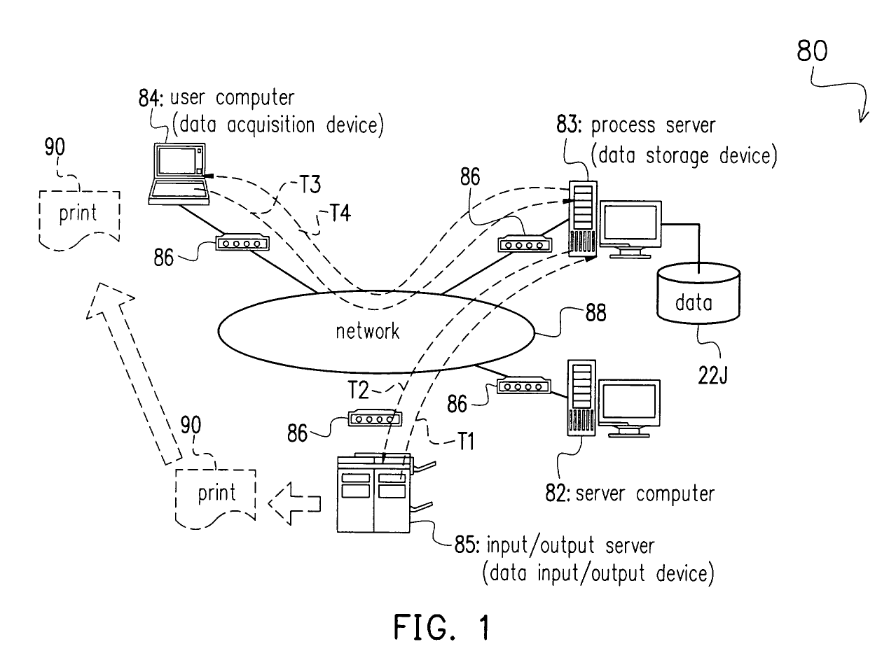

FIG. 1 schematically illustrates a configuration of a computer network system according to the first embodiment of the invention. The computer network system 80 can be a distributed network system. Under the distributed network environment, each user connected to the network doesn't need to know the locations of resource objects, such as program or data. In addition, procedures executed by the computers are also distributed to be held and managed. For example, a process that is being processed at one computer connected to the network can call a procedure to execute a process that is being processed at another computer.

In the embodiment, the computer network system 80 is composed of a network 88, such as the Internet or other small scale networks (local area network (LAN), for example). The network 88 can be composed of a communication network, such as public telephone networks provided and built by telephone companies at each country or area. The communication network, for example, includes a public switched telephone network (PSTN) or an integrated service digital network (ISDN). The communication network can further include a personal digital cellular (PDC) or personal handyphone system (PHS). In addition, when the network 88 and the communication network are built in different networks, the network 88 and the communication network can be connected through a gateway system.

The communication network can definitely provide a transceiving function of data for a portable end device. Preferably, it is better that the communication network can provide functional services, for example, a function for giving a location data of the portable end device that is registered in cells of each station and an authentication function for a caller identification (caller ID).

On the network 88, such as the Internet, user computers 84 and various server computers are respectively connected by connection devices 86, such as a modem, a router, or a terminal adapter (TA), etc. Information can be received and transmitted among the above computers by mutually communicating through the network 88.

In the network 88, the Internet or its respective small scale networks can be connected to each other through the connection (communication) devices 86, such as the modem or router etc. Therefore, the computers on the network mutually access each other according to a predetermined communication protocol, such as the transmission control protocol/internet protocol (TCP/IP). A number of end hosts and end users can be connected together on the computer network system 80. On the computer network system, a portion of the computers are “servers” to provide various resource services and the others are “clients” that request of the servers a resource service, which performs a function known as a server-client system.

An exemplary server is a world wide web (WWW) server on a WWW system that is built according to the TCP/IP protocol on the Internet. The WWW server can provide the resource object of hyper text transfer protocol (HTTP) composed of hyper text markup language (HTML) content etc. The other exemplary servers are mail servers that can provide each user account with the electronic mail receiving/transmitting service, database servers or file servers etc.

For example, a server computer 82 includes a process server 83 and an input/output server 85. The detailed operations of these servers are described later in following paragraphs. The process server 83 receives image data that is read at the input/output server 85, stores the image data and then replies a storage location to the input/output server 85. The input/output server 85 reads an image that is specified by a user, transmits image data of the read image to the process server 83, and outputs (prints) the storage location that is replied by the processing server 83.

The processing server 83 is not limited to storing image data. A storage server for storing image data is connected to the network 88, for example. Instead of storing the location that stores the image data, the processing server 83 stores the location (uniform resource locator, URL) of the storage server, and therefore the image data can be stored in the server located at that location.

In the description, a single machine is used for describing each kind of server computer. However, the invention is not restricted to use only a single machine for each kind of server computer, in fact plural machines can be used. The server computers can also be arranged together. The processing server 83 is referred to as a data storage device 83 and the input/output server 85 is referred to as a data input/output device in the following description. The user computer 84 is also referred to as a data acquisition device 84.

The small-scale network, such as the LAN, can be operated by a particular organization or corporate group etc., and can be connected to an external wide area network (WAN) through a firewall (not shown) for example. Accordingly, the access to the external network can be restricted. When the LAN is owned and managed by a specific corporation, a variety of contents of documents or data, etc., related to the corporation are stored in the servers built on the LAN. When the proper authority is given by the corporation and is known by a predetermined procedure, the client can get permission to access the servers.

The contents can be electronic information contents containing image data, and more particularly, can be information contents that are processed in the computers and distributed on the Internet. In addition, the contents contain information that should be provided and contains various data, such as the text data, graphic data, or multimedia data.

Various input devices, such as the keyboard or the mouse, are assembled to the computer for inputting instructions or commands to the computers, and a display is installed for displaying the processed result by the computer. The computer further includes wide-use and general hardware components, which are well known to those skilled in the art and so their detailed descriptions are omitted.

When the data is transmitted or received through the network 88, a WWW browser is installed in a computer or an end device and then is activated so that any computer can access the data. At this time, the access location, which is data including a location of the server to be accessed and a location of information within the server, etc., can be assigned by the format of Uniform Resource Locator (URL).

The following descriptions are an overview of the information transfer on the above computer network system 80. The computer network system 80 according to the embodiment of the invention can be composed of the data storage device 83, the data input/output device and the data acquisition device 84.

Taking a look at the flow chart of the data output, the user uses the data input/output device 85 to read an image, such as an original that the user hopes to store. The data input/output device 85 transmits the image data to the data storage device 83 (data transmission T1). The data storage device 83 receives the image data from the data input/output device 85 and stores it in the memory 22J, such as a storage database. The data storage device 83 gets the storage location in the memory 22J, and then transmits the storage location to the data input/output device 85 (data transmission T2). The data input/output device 85 receives the storage location data of the image data from the data storage device 83 and then prints the storage location data. Accordingly, the user can obtain a printout 90 that the storage location of the image data read at the data input/output device 85 has printed. The user can possess the printout 90 and uses the user computer 84, which the user operates at a place away from the user's house, to transmit the data that requests to acquire the image data to the data storage device 83 (data transmission T3). The data storage device 83 receives the request from the user computer 84 and replies with the image data stored in the memory 22J to the user computer 84.

By means of the above computer network system 80, any user can input the image data at any place without preparing a high precision scanner or a storage device with a large capacity, and can request a data output at any location (the user computer, for example).

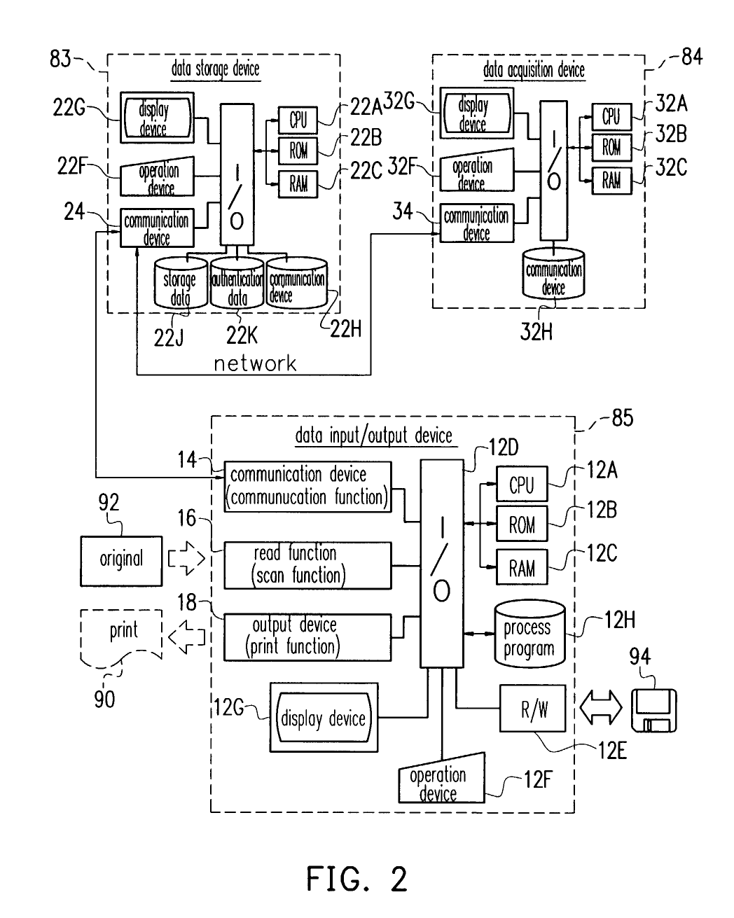

FIG. 2 schematically illustrates a data transfer main frame according to the embodiment of the invention. Each configuration of the data storage device 83, the data input/output device and the data acquisition device 84 is depicted by a block diagram and described in detail as follows.

Data Input/Output Device

The data input/output device 85 is a multi-function machine that manages an information output device (a printer, for example) existing on the network and controls in general an information output request, such as a print request issued on the network. That is, as well as being the printer printing the image and the documents processed by the computer, the data input/output device 85 can be a multi-function machine capable of providing other functional services such as copy or facsimile. The data input/output device 85 can be set at public areas where people can easily gather, for example, convenience stores, college student cooperatives, gas stations or service areas on the highway, etc., and thereby the data input/output device 85 can be shared by an indefinite number of users.

The data input/output device 85 is connected to the network 88 at a predetermined site (an IP address), but is not limited to the established location of the server. The location of the data input/output device 85 on the network can be assigned by the IP address or the URL.

The data input/output device 85 is composed of a microcomputer, in which a CPU 12A, a ROM 12B, a RAM 12C, an I/O device 12D can be connected to transfer data or commands. In addition, a read/write device 12E such as a floppy disk drive, an operation device 12F such as a keyboard, a display device 12G such as a display and a memory 12H for memorizing a process program are connected to the I/O device 12D. When the process program is memorized in the ROM 12B or the RAM 12C, the memory 12H is not necessary.

The read/write device 12E is capable of inserting or removing a storage medium 94. The storage medium 94 includes a floppy disk, for example. Process routines described below can be executed from the storage medium 94 using the read/write device 12E. Therefore, the process routines described below can be stored in the storage medium 94 without storing in the memory 12H, and process programs stored on the storage medium 94 can be executed through the read/write device 12E. Alternatively, a mass storage device such as a hard disk can be included within the data input/output device 85 so that the process programs stored in the storage medium 94 can be installed to the mass storage device and then executed. The storage medium can be a disc medium such as a CD-ROM, MD, MO, DVD etc., or a magnetic tape such as DAT, etc. When one of the above storage medium is used, the above read/write device 12E may be a CD-ROM device, a MD device, a MO device, a DVD device and a DAT device correspondingly.

In addition, the I/O device 12D also connects to a communication device 14, a read device 16 and an output device 18. The communication device 14 includes the communication device 86 shown in FIG. 1 for connecting to the network 88, and is used for executing a communication between the output device 18 and an external device. The read device 16 can possesses a function of scanner that is capable of scanning an original 92 and then reading its image data. The output device 18 possesses a function of a printer, and is used for printing out an image data or text data as print 90 from the output device 18.

One exemplary function that the data input/output device 85 has is a charging process. The charging process is a service (or function) executed by the data input/output device 85. That is, the charging process requests the user for a suitable expense for the information input/output service. For example, the service includes a process for scanning the original 92 and then generating the image data, a process for communicating with the external device using the communication device 14, a process for obtaining a printout 90 from the output device 18, and a process for executing programs to read data from the storage medium 94, etc.

The charge information, such as the charge system, in the data input/output device 85 can be set in advance, or obtained from the external device. Namely, the management of the charge information of all information input/output can be concentrated to the data input/output device 85. Additionally, it is possible that only the charge process is performed and the charge information is transmitted to the data provider. The charge process from the external device can be performed through the communication network or other network. For example, a charge system corresponding to a level of the output service, such as a print out to a color print or high quality paper, can be changed.

As described above, the data input/output device includes the read device 16 and the output device 18, but such configuration doesn't limit the scope of the invention. For example, each device can be individually connected to the network, or connected through a leased line.

Data Storage Device

The data storage device 83 can store the image data obtained from the data input/output device 85 in a memory device 22J, or acquire the image data from the memory device 22J. Processes executed at the data storage device 83 can be executed within the data storage device 83, or a remote procedure call such as a Common Gateway Interface (CGI) can be used to entrust other servers on the network to execute the program. For example, a memory device for storing the image is prepared independently, and the data storage device 83 can present an address to that storing device.

For example, similar to the data input/output device 85, the data storage device 83 is composed of a microcomputer, in which a CPU 22A, a ROM 22B, a RAM 22C, and an I/O device 22D can be connected to transfer data or commands. In addition, a read/write device 22E, an operation device 22F and a display device 22G are connected to the I/O device 22D. The I/O device 22D is also connected to a memory 22H for storing the process programs, a memory 22J for storing the image data and a memory 12K for storing authentication data that is used for accessing the image data stored in the memory 12J. Additionally, the I/O device 22D is also connected to a communication device 24.

The image data from the data input/output device 85 is transmitted to the data storage device 83. The data storage device 83 has a function capable of managing the image data received from the data input/output device 85. Namely, the data storage device 83 has a storage function for storing the image data received from the data input/output device 85 and an acquisition function for acquiring and then transmitting the image data assigned by another computer.

The data storage device 83 can be provided with the charging process function. The charging process function is to request the user for the charge that is generated due to the function for storing the received image data. Therefore, the user to be charged is the user that uses the data input/output device 85 to read the original 92, and there are two manners to charge the user.

The first one is to charge the expense for the storage function only. The expense for the storage function is preset and the user is requested to pay the preset expense accordingly. This requested expense, for example, can be added together with the expense that the user pays for using the data input/output device 95. In addition, a settlement site established by a credit or a loan company etc. can be requested to use the user information.

Secondly, in addition to the expense for the storage function, even the expense generated by obtaining the other data is collected, both of which are managed. In addition to the expense of the above storage function, even the expense generated by obtaining the other data is collected. If the expense is created when the stored image data is acquired and transmitted, this expense is added to the expense of the storage function and then charged. The management is to create a bill of the expense generated for each item, and the bill contains the site, data, date and capacity that the user used.

Regarding the storage of the image data, if a third person accesses the image data, the user's privacy is compromised. Therefore, the data storage device 83 further possesses another function, an authentication process. The authentication process issues authentication information (for example, a password) for the access of the image data, and the access to the image data is permitted only when the input password is consistent with the issued password.

Data Acquisition Device

The data acquisition device 84 is a computer (the user computer 84) that the user can operate to acquire or read the image data stored in advance (read and stored at the data input/output device 85). In addition, the data acquisition device 84 can be a stationary computer, or a portable end user device such as a PDA.

For example, similar to the data input/output device 85, the data acquisition device 84 is also composed of a microcomputer, in which a CPU 32A, a ROM 32B, a RAM 32C, and an I/O device 32D can be connected to transfer data or commands. In addition, a read/write device 32E, an operation device 12F, a display device 32G and a memory 32H for memorizing process programs are connected to the I/O device 32D.

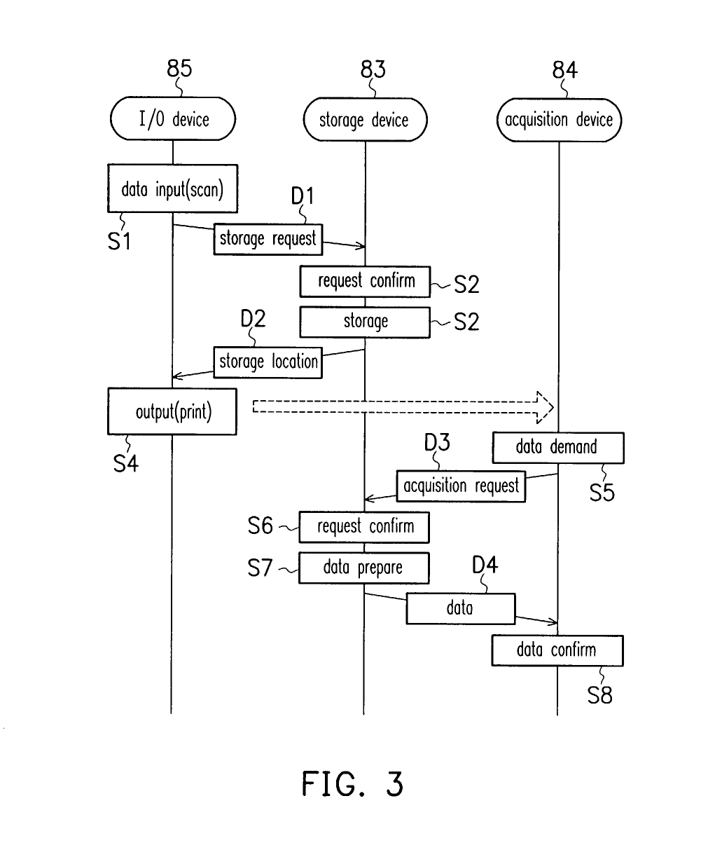

FIG. 3 schematically illustrates a flow chart for the information transfer on the computer network system according to the embodiment of the invention.

The following descriptions are operations and functions according to the embodiment of the invention. In this embodiment, the input/output device serves as an input device and the data storage device having a server function receives the input digital data through the communication network, and then stores the digital data. The access information for accessing the storage location of the digital data that the data storage device stores, and the print instruction of the access information, are returned (transmitted) to an external device having a print function (the data input/output device).

First, when the user wants to store an image data, the original 92 is scanned to create the image data at the data input/output device 85 (process S1). In addition, the invention isn't limited to the image data created by scanning the original 92. For example, the image data can be read by the read/write device 12E from the storage medium 94.

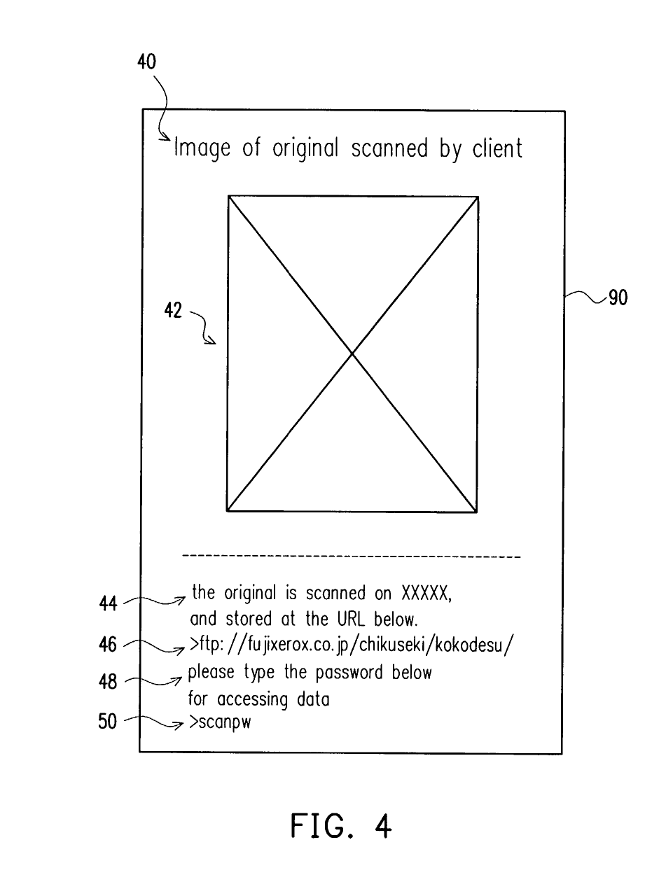

The data storage device 83 is requested to execute a request for storing the image data (data D1). The data storage device 83 receives the request and gathers the request contents (process S2), and then stores the image data (process S3). The storage location of the stored image data is transmitted to the data input/output device 85 (data D2). As the data input/output device 85 receives the data from the data storage device 83, a print 90, that will be described later, is printed out (process S4) as shown in FIG. 4. Therefore, the user can be informed of the storage location of the stored image data by reference to the printout 90.

The user then carries the printout 90 and moves to a location capable of acquiring the image data, at which the data acquisition device 84 can be operated. When a portable end device such as the PDA, etc. is used as the data acquisition device 84, the location is not fixed, and the location of the data acquisition device 84 is theoretically capable of connecting to the network 88.

When the user utilizes the above stored image data, a demand process for acquiring the stored image data is executed (process S5) by referring to the printout 90 and operating the data acquisition device 84, and then the data storage device 85 is requested (data D3). The data storage device 85 receives data from the data acquisition device 84, gathers the demand contents (process S6), and then prepares the image data that is stored in the assigned location. When the image data is ready, the image data is transmitted to the data acquisition device 84 (data D4). The data acquisition device 84 receives the image data from the data storage device 85, and then displays, stores and confirms the image data (process S8).

As described above, because the user makes a storage request for the image data and then the result of the request can be obtained from the printout 90, the stored image data can be used at any place.

The storage location of the image data can be assigned to a URL that stores the image data. In addition, the location where the image data is stored can be assigned to a URL of the storage device.

The processes of the components of the system including the data storage device 83, the data acquisition device 84 and the data input/output device 85 are described in detail below.

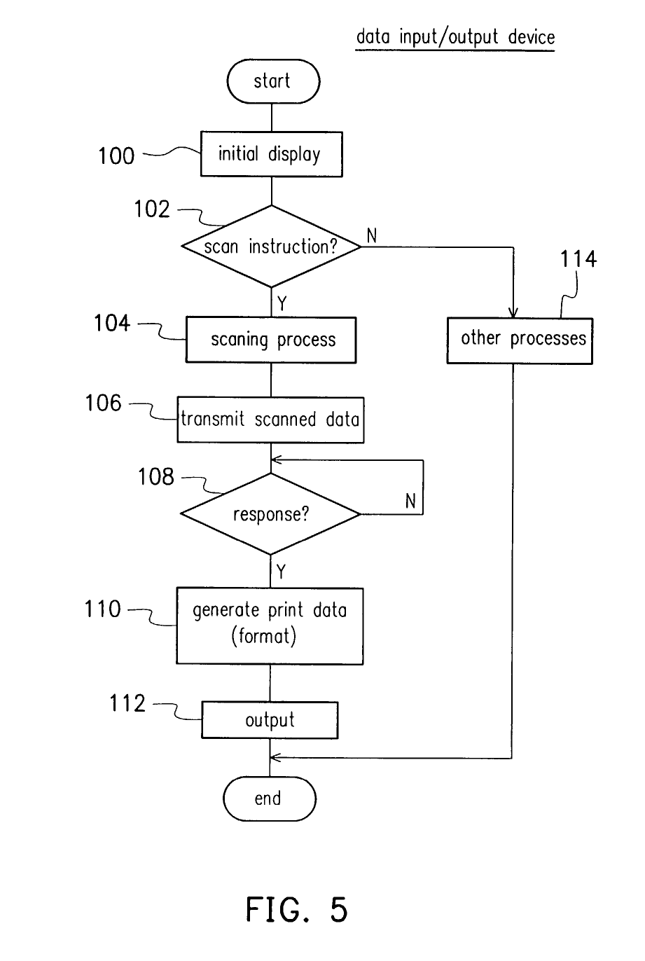

First, the data input/output device 85 that initially deals with the image data executes a process routine shown in FIG. 5. As shown in FIG. 5, at step 100, an initial display process is executed. The initial display process prompts the user who operates the data input/output device 85 (the multi-function machine) to select from the selection instructions that are used for selecting an operational function. For example, a format information is received and shown on a selection screen displayed on the display device 12G of the data input/output device 85 for selecting a function of copy, print or scan, etc.

Next, at step 102, from the selection screen displayed at step 100, it is determined whether a request for storing the image data is made by determining if an input instruction that represents the scanning function is selected has been made. When the user gives an instruction other than the scanning function, a negative decision (N) is made such that step 114 is executed to perform other processes. The process routine is terminated after the other processes are executed at step 104.

When the user instructs a scanning function, a positive decision is made at step 102 and then step 104 is executed. The scanning process scans the original 92 prepared by the user to create an image data. When the scanning process is finished, step 106 is executed. The image data obtained at step 104 is transmitted to the data storage device 83. When the image data is transmitted to the data storage device 83, the URL or IP address, etc., that represents the location of the data input/output device 85 is also transmitted to the data storage device 83.

As described above, the request for storing the image data is performed. Therefore, the processes in steps 100 to 106 correspond to the process S1 for creating the image data and the transmitting process of the data D1 to request the storage of the image data.

Steps 102 to 106 describe that the original 92 is scanned to create the image data and then transmitted, but the description is not to limit the scope of the invention. For example, the image data can also be obtained by reading from the storage medium 94 through the read/write device 12E of the data input/output device 85 (referring to FIG. 2). In such a situation, step 102 determines a reading instruction, step 104 executes the reading process and step 106 transmits the image data that is read.

At step 108, it is determined whether a response corresponding to the transmission at step 106 is received or not from the data storage device 83. That is, at step 108, a negative decision (N) is repeatedly sent until the data storage device 83 responds to the transmission made at step 106. When a positive decision (Y) is sent at step 108, step 110 is executed to generate the print data. The replied data is printed according to what kind of format (for example, the arrangement and size) is used, and then the generation of the print data is generated based upon the format. The generated print data is printed at next step 112 and then the process routine is ended. The responded data includes a storage location (URL, etc.) that is requested to store the image data. Additionally, in order to effectively confirm the stored image data, a portion of the scanned image can be printed when the print data is printed.

Step 112 includes a charge process to a service that the image data of the original 92 is requested to store and then the printout 90 showing that the image is stored has been obtained. This charge process is to request to charge the user with a predetermined expense with respect to a series of the services or a portion of the services. The charge process can be processed individually before or after the above processes. For example, a charge process can be added after the above processes or an early charge process can be added before the above processes are executed.

As described above, the printout 90 can be obtained so that the user can easily confirm the storage location of the image data of the original 92 that has been requested. Therefore, the processes of step 108 and step 110 correspond to the printing process S4 shown in FIG. 3.

FIG. 4 shows an example of the printout 90 on which the received data from the data storage device 83 is printed at the data input/output device 85. The exemplary printout 90 includes print areas 40, 42, 44, 46, 48 and 50. As shown in FIG. 4, using the format set at step 110, the printout 90 includes a portion of the scanned image 42, the location of the stored image data 46, and the area that prints the password for accessing the image data 50.

The print area 42 is used for printing a portion of the image data obtained from the original 92 that is an object of the printout 90. A caption to the image is printed in the print area 40. The image itself can be directly printed as an image printed in the print area 42, or the resolution of the image can be changed (for example, to reduce the resolution) and then printed as an image printed in the print area 42. A portion of the image can be also used. In addition, the image data of the image printed in the print area 42 can use the data that is scanned at the data input/output device 85 or received from the data storage device 83

The print area 44 is used for printing the time information (for example, time and date in the embodiment) when the image data scanned from the original 92 was requested. The size of the image data can be also added to the print area 44. The print area 46 is used for printing the storage location (URL, etc.) of the image data. As shown in FIG. 4, the storage location (URL) is printed in computer syntax (ftp://fujixerox.co.jp/chikuseki/kokodesu).

The print area 50 is used for printing the password serving as identification information of authentication when accessing the stored image data. The print area 48 is used for printing a caption corresponding to the password. The password can be set and managed by the data storage device 83.

Preferably, items printed on the printout 90 can at least include the storage location of the image data and the password if the identification information (password) for accessing the image data is set.

Next, a process executed by the data storage device 83 is described in detail as follows.

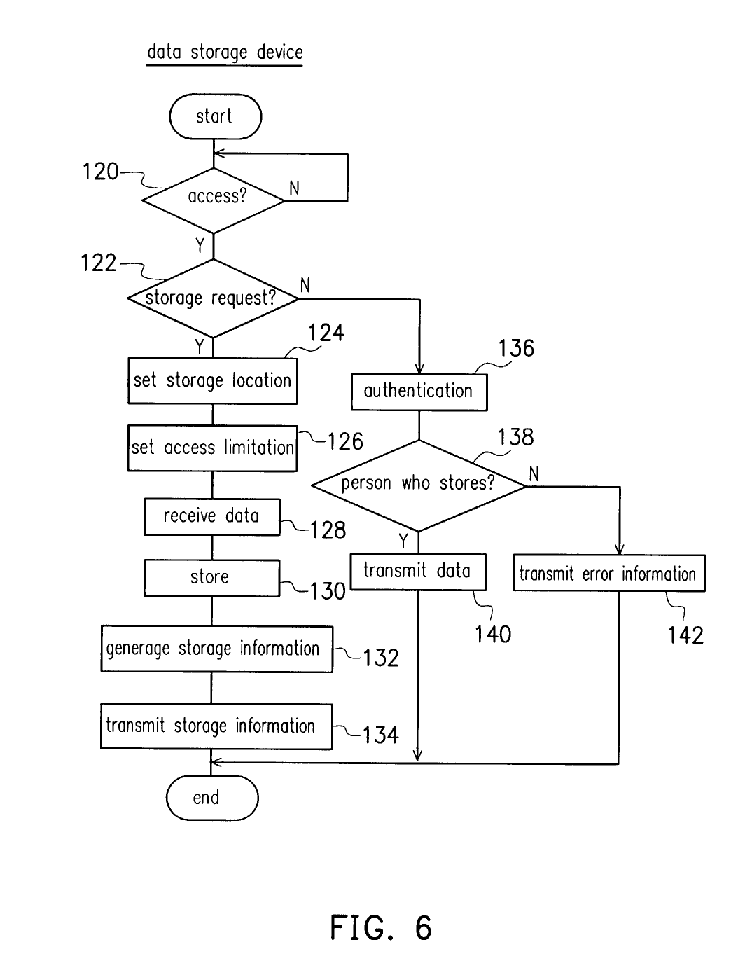

FIG. 6 schematically illustrates a flow chart of a process routine executed by the data storage device 83. As shown, step 120 determines whether an access request is made from another device or not. Step 120 makes a negative decision (N) until the access request is made. When step 120 makes a positive decision (Y), then step 122 is executed. At step 122, it is determined whether the access request is a storage request of the image data or not. When the access request is a storage request, step 122 makes a positive decision (Y) to execute step 124, otherwise, step 122 makes a negative decision (N) to execute step 136. Therefore, the determination processes of steps 120 and 122 correspond to the reception processes of data D1 and process S2 for confirming the request in FIG. 3

At step 124, the storage location of the image data that has been requested to be stored is set. Next, step 126 sets an access limitation to the stored image data. At step 124, the storage location (URL, etc.) in the memory 22J is set. This setting can also secure a storage range for the location. At step 126, identification information for accessing the image data stored in the memory 22J is generated and set. At step 126, a look-up table of the storage location and its corresponding identification information is generated and then stored in the memory 22K.

At step 128, the image data that has been requested to be stored is received. At step 130, the received image data is stored in the storage location that has been previously set. At step 132, storage information is generated for showing the storage location of the image data that was set at step 124. At step 134, the storage information is transmitted to the data input/output device 85. The transmission at step 134 is a reply process to the location corresponding to the device that requests the access request at step 120, i.e., the data input/output device 85.

Therefore, the processes of steps 124 to 130 correspond to the process S3 for storing the image data in FIG. 3. In addition, the processes of steps 132 and 134 correspond to the transmission process of data D2 in FIG. 3.

As described above, the image data is stored according to the storage request from the user, and the storage location (URL, for example) of the stored image data is replied to the user. When the image data is stored and the storage location has been replied, the process routine is terminated.

In addition, when step 122 makes a negative decision (N), an authentication process is executed at step 136. The process of step 136 is used for determining whether the access to the image data stored in the memory 22J is an access from a legal user. Namely, at step 136, the user (the data acquisition device 84) that requests the access is requested to input a password of the identification information. When the replied password (the input password) is obtained, the data storage device 83 refers to the look-up table stored in the memory 22K to obtain a legal password.

At step 138, it is determined whether the user that currently requests the image data is a user permitted by the user that has requested to store the image data according to a determination whether the legal password and the input password are consistent. At step 138, if a positive decision (Y) is made, which means the user that currently requests the image data is a legal user, then step 140 is executed. The stored image data is transmitted to the device that requests to access the image data (the data acquisition device 84), and the process routine is terminated.

On the other hand, if a negative decision (N) is made at step 138, which means the user that currently requests the image data is not a legal user, then step 142 is executed to send error information to the device that has requested to access the image data (the data acquisition device 84) and the process routine is terminated.

Therefore, the processes of steps 120 to 122 and 136 to 140 correspond to the reception process of data D3 and the process for confirming the request in FIG. 3. In addition, step 142 executed according to a negative decision at step 138 corresponds to the transmission process of data D4 in FIG. 3.

Next, a process executed by the data acquisition device 84 is described in detail as follows.

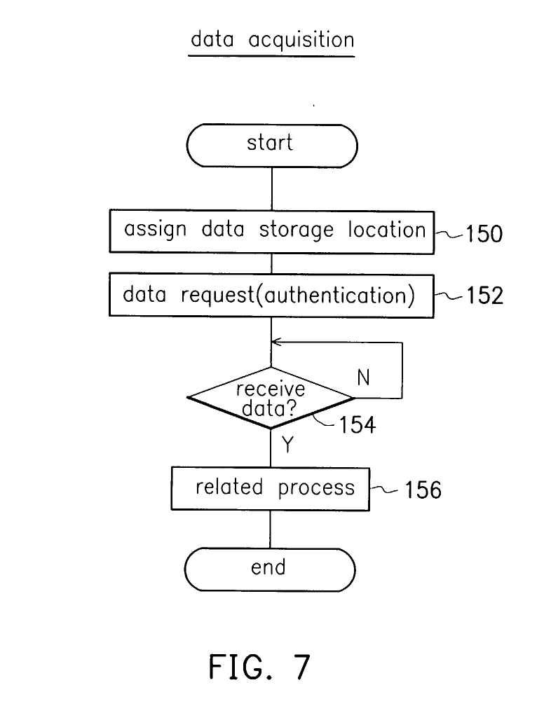

FIG. 7 schematically illustrates a flow chart of a process routine executed by the data acquisition device 84. First, at step 150, the storage location of the image data for the access request to the data storage device 83 is assigned. The user refers to the printout 90 and then inputs the storage location (URL, etc.) of the memory 22J of the data storage device 83. Step 152 executes a data request process. The data request process performs an access request for the image data by transmitting a data, i.e., the storage location assigned at step 150. At this time, the data storage device 83 executes the above authentication process to request the user to input a password. Therefore, step 152 includes a password inputting process for the above authentication process.

Next, at step 154, a negative decision (N) is repeatedly made until the image is received from the data storage device 83, and when a positive decision is made, step 156 is executed to receive the requested image data. Afterwards, at step 156, a utility (related process) for processing the image data, such as software for displaying the image, is executed, and then the process routine in FIG. 7 is terminated.

Therefore, the processes of steps 150 to 156 correspond to the reception process of data D4 and the process S8 for confirming the image data.

According to the embodiment described above, the user utilizes the data input/output device 85 to read the original for generating the image data, and then the image data is transmitted to the data storage device 83 for storage. The data storage device 83 stores the image data from the data input/output device 85 into the memory 22J, and then transmits the storage location of the image data to the data input/output device 85. The storage location of the image data is received and printed by the data input/output device 85. Therefore, the storage location of the image data that is generated by reading the original 92 can be confirmed by the printout 90 at the location where the original 92 is read (the data input/output device 85). The user can also access the image data at any place that the user intends.

According to the embodiment described above, theoretically and actually, according to the user's request, the user who has no regular living place can access the stored image data at any place by such as a portable end device or a end user device that the user has. The acquired image data can be further processed according to the user's purpose and application.

The processes of steps 128 to 134 correspond to storing the digital data of the invention and transmitting the access information, the print instruction, input digital data and advertising information and so on to an external device (for example, the data input/output device 85). Moreover, audio data or image data, such as a still picture or an animation can serve as the digital data. When transmitting the storage information, the transmitting of at least a portion of the image data of the stored image corresponds to the transmitting of the identification information of the invention.

Considering an example of plural image data items, the storage information generated at step 132 can include plural storage locations (URL, etc.) of image data items.

When the stored image data includes plural image data items, the image data transmitted at step 134 is a predetermined image that is used as a representative image, which can be an image at the first page, at the final page, at a preset page or at a user-assigned page, for example.

<<Second Embodiment>>

Next, the second embodiment according to the invention is described. Because the second embodiment substantially has the same configuration as the first embodiment, the same elements are labeled by the same numbers and their corresponding detailed descriptions are omitted.

In the first embodiment, only one storage location received from the data storage device 83 is printed on the printout 90. However, in the second embodiment, plural locations are received from the data storage device 83. The second embodiment is suitable for distributing the stored image data to a number of users.

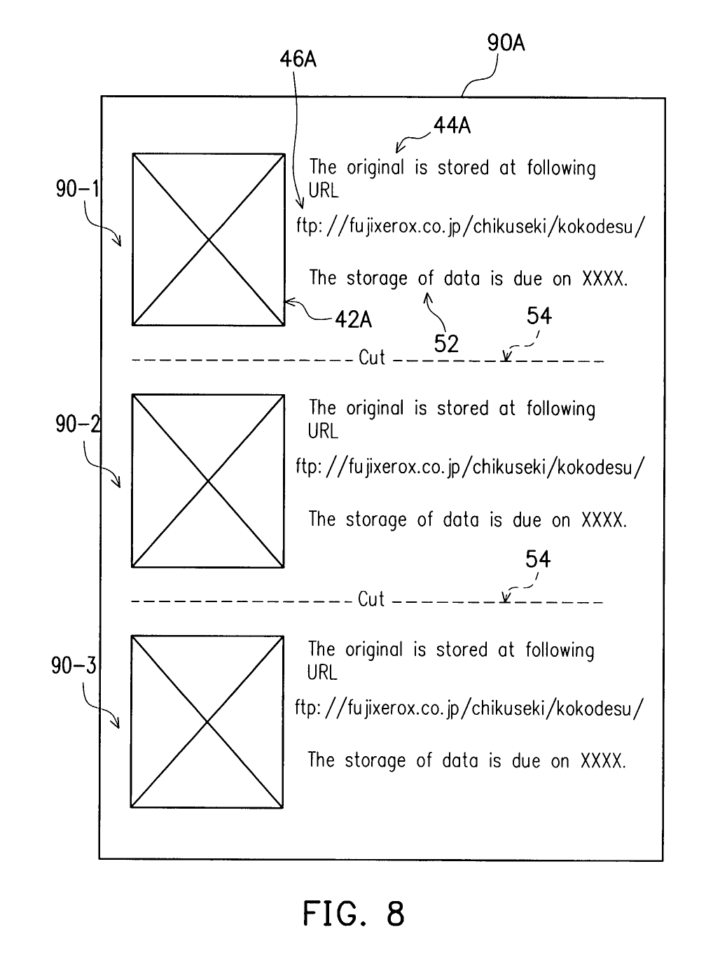

FIG. 8 shows an example of a printout 90A printed by the data input/output device 85 based upon the received data from the data storage device 83 according to the second embodiment. The printout 90A includes three same print areas 90-1, 90-2 and 90-3, for example. There is no limitation such that only three print areas are on the same printout, two or four print areas can be also formed on the same printout. The three same print areas, 90-1, 90-2 and 90-3, can be cut by cutting lines 54, to be kept by the user.

The first print area 90-1 includes print areas 42A, 44A, 46A, and 52. The print area 42A is similar to the print area 42 of the printout 90 in FIG. 4, and is used for printing a portion of the image data of the original. The print area 44A is used for printing a message concerning the stored image data of the scanned original 92. The print area 46A is similar to print area 46 of the printout 90 in FIG. 4, and is used for printing the storage location (URL, etc.) of the stored image data. The print area 52 is an additional item added to the printout 90A, which is used for printing an effective (due) date (date and time in the embodiment) of the stored image data. The due date printed in the print area 52 is a deadline for accessing the stored image data, which can be set by the data storage device 83.

Additionally, because the second print area 90-2 and the third print area 90-3 have the same arrangement as the first print area 90-1, their descriptions are omitted.

In order to obtain the above printout 90A, the following processes can be executed in each device.

To replace the identification information (the password) that is set at step 126 in FIG. 6 for restricting the access, the data storage device 83 sets an effective storage period for the image data. However, the identification information (the password) can be also set together with the effective storage period. At step 126, the management for the effective storage period has to be executed separately. Regarding this management, a timer is set in the data storage device 83, and the image data can be accessed within the effective storage period based on the timer. Over the effective storage period, it is preferable to execute a predetermined process to erase or move the image data. Moreover, the data storage device 83 can let the user that requests the storage preset a process as if the time is over the effective storage period, or inquire the user when the effective storage period is near.

At step 110 in FIG. 5, the generating process of the print data is changed from the format in FIG. 4 to the format in FIG. 8. For example, the print data with a format including three same print areas 90-1, 90-2, 90-3 and the cut lines 54 are generated. The printout 90A in FIG. 8 can be obtained by printing the above generated print data.

As described above, the printout 90A can be obtained, by which the storage location of the image data that is requested to be stored by the user can be easily confirmed.

The previous description is a situation where the data input/output device 85 generates a print data having plural patterns, but that description is not used to limit the scope of the invention. For example, the data storage device 83 transmits the formatted image data to the data input/output device 85, and the received image data can be printed on only one page. In this situation, an image field is not limited to print only one single image, the image can be a composite image including plural images. This composite image can use an image that is generated by editing and processing at the data storage device.

Additionally, the previous example describes the case where the same plural images are contained on one page, but the description is not used to limit the scope of the invention. The same plural images can also be formed on respective plural pages.

<<Third Embodiment>>

Next, the third embodiment according to the invention is described. Because the third embodiment substantially has the same configuration as the first or the second embodiment, the same elements are labeled by the same numbers and their corresponding detailed descriptions are omitted.

In the previous embodiment, it is described that the storage location of the image data is printed to obtain the printout 90 or 90A. However, according to the third embodiment, the image data is stored in the storage server, and the location of the storage server will be printed out. The third embodiment is suitable for any situation where the storage server is used.

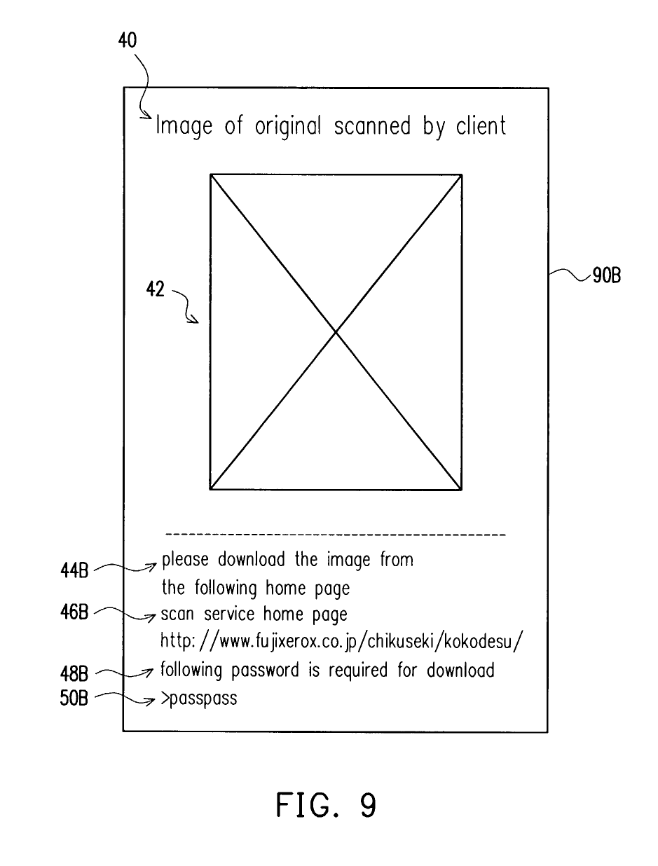

FIG. 9 shows an example that a printout 90B is printed by the data input/output device 85 based upon the received data from the data storage device 83 according to the third embodiment. The difference from the printouts 90 and 90B is that the contents should be printed in the print areas. For example and as shown in FIG. 9, the print areas 44, 46, 48 and 50 are changed to the print areas 44B, 46B, 48B and 50B.

According to the third embodiment, the storage location is the URL location of a Home Page established on the storage server. In detail, the print area 44B is used for printing captions, which show a message that the location storing the image data is the Home Page and a message to perform a reading (download) process. The print area 46B is used for printing the location (URL, etc.) of the Home Page that stores the image data, which is printed by a computer notation (http://fujixerox.co.jp/chikuseki/kokodesu) as shown in FIG. 9.

The print area 50B is used for printing the identification information (the password, for example) for the authentication when accessing to the Home Page, and the print area 48B is used for printing a caption corresponding to that password. This password can be set and managed by the data storage device 83, or by the storage server.

In order to obtain the above printout 90B, the following process can be executed by the data storage device 83.

At step 124, the data storage device 83 sets the storage location of the image. The storage server predetermined by the memory device 22J or the location (URL etc) storing the Home Page is set as the storage location. Step 130 in FIG. 6 is a process for storing the image data, whereby the storage request is performed with respect to the predetermined storage server or the Home Page, to which the image data is transmitted. At this time, it is preferable to send the identification information (the password) together.

As described above, the printout 90B can be obtained, by which the storage location of the image data that is requested by the user can be easily confirmed.

<<Fourth Embodiment>>

Next, the fourth embodiment according to the invention is described. Because the fourth embodiment substantially has the same configuration as the previous embodiment, the same elements are labeled by the same numbers and their corresponding detailed descriptions are omitted.

In the previous embodiment, the printout 90, 90A or 90B contains data relevant to the image data of the original 92 that is requested. Namely, the storage location received from the data storage device 83 is printed. However, in the fourth embodiment, some information items from which the user can benefit is added. In the fourth embodiment, it is preferred that the user is informed of various services.

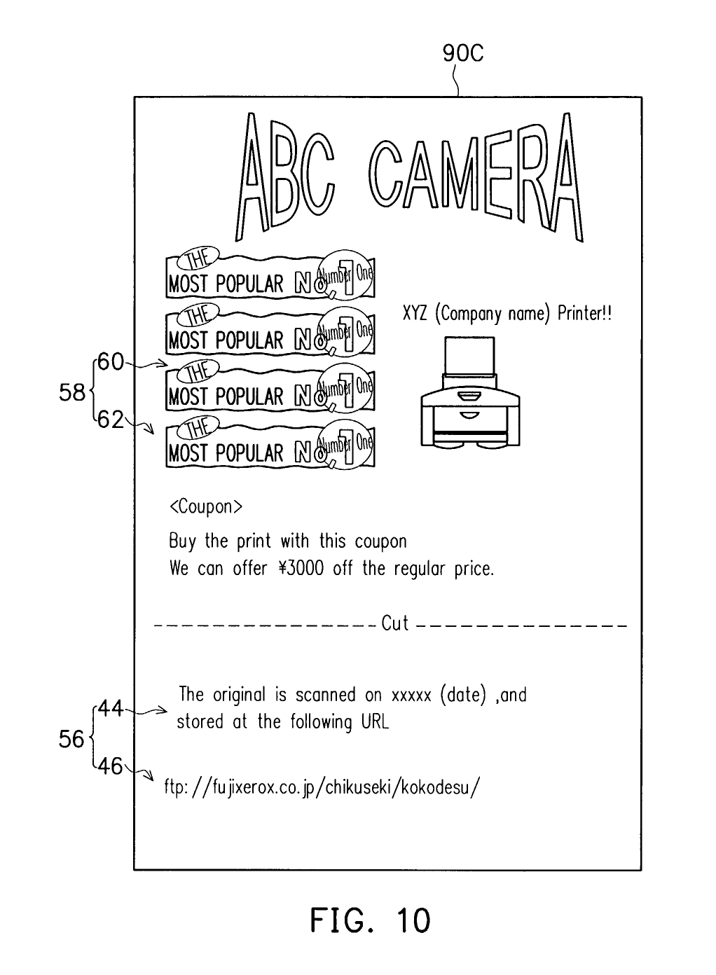

FIG. 10 shows an example where a printout 90C is printed by the data input/output device 85 according to the fourth embodiment. The printout 90C includes two print areas 56, 58. There is no limitation that the number of the same print area is three, two or four or more. The two print areas 56 and 58 can be cut by a cut line 55 to store. Similar to the printout 90, the print area includes the print areas 44 and 46.

The print area 58 is composed of a print area 60 of advertising information and discount information (coupon).

The print area 60 is used for printing the advertising information that is made by a maker, a cooperation, or any group that hopes to issue information, and can be a text data or an image data. The advertising information printed on the print area 60 can be set and managed at the data input/output device 85, or at the data storage device 83. Additionally, the advertising information printed on the print area 60 can be also set and managed at other computer.

The print area 62 is used for printing discount information that is made by a maker, a cooperation, or any group who hopes to issue information, and can be a text data or an image data. The discount information printed on the print area 62 can be set and managed at the data input/output device 85, or at the data storage device 83. Additionally, the discount information printed on the print area 62 can be also set and managed at other computer.

For example, in order to obtain the above printout 90C, the following process can be executed by the data storage device 83.

At step 110 in FIG. 5, the generating process of the print data is changed from the format in FIG. 4 to the format in FIG. 10. For example, the print data with a format including two print areas 56, 58 and the cut lines 55 is generated. At step 110, in order to print the advertising information and the discount information to the print area 58, a process for reading the information from the memory is added.

Namely, in order to read the advertising information and the discount information, the data input/output device 85 stores the data of the advertising information and the discount information in the memory, for example the memory 12H, in advance. Therefore, at step 110, the data received from the data storage device 83 and the advertising information and the discount information that are read from the memory forms storage information including the advertising information, the discount information and the image data, and therefore a print data containing the storage information is generated. The printout 90C shown in FIG. 10 can be obtained by printing the generated print data.

In addition, the advertising information and the discount information can be stored in the storage medium 94, then read and stored by the data input/output device 85. In the previous description, the advertising information and the discount information are stored in the data input/output device 85 in advance, but this description is not to limit the scope of the invention. For example, the advertising information and the discount information can be received from the data storage device 83.

For example, at step 134 in FIG. 6, the advertising information and the discount information can be added to the storage in the formation that it is to be transmitted.

Any of the advertising information and the discount information can be used independently. Furthermore, there is no limitation that both of the advertising information and the discount information have to be stored in the same place. Namely, at least one of the advertising information and the discount information can be stored in any one of the devices that connected to the network 88.

As described above, the printout 90C can be provided, by which the storage location of the image data that is requested to be stored by the user can be easily confirmed and the advantageous information for the user can be added.

In this embodiment, the advertising information and the discount information are added to the printout that is used for confirming the storage location of the image data that is requested to be stored by the user. Regarding the service that provides the additional advertising information and the discount information, the charged expense of the above charging process can be changed. For example, for the printout 90C with additional advertising information, the charged expense can be reduced. Accordingly, the charged expense can be lower than the usual charged expense and the will for the user to use this service increases. The change of the charged expense can be done for each charge item entirely. The charged expense can be changed by setting a certain amount or a discount percentage for each classified charge item (for example, the scan charge or the storage charge).

In the previous embodiments, the image data obtained by reading (scanning the original or reading from the storage medium) is directly stored in the data storage device, but this description is not to limit the scope of the invention. For example, a service that converts the image data obtained by reading to a predetermined format can be added. For example, an image data of a bitmap format can be converted to a compressed data format (for example, JPEG data format) that is mainly used in the network (such as the Internet), and then stored. In addition, when the image data is a multiple color image data, a service can reduce the color bits to that preferred by the machine printing or the computer displaying. Namely, no matter the type or specification of a device for generating the image data and the type or specification of an output device, display or print can be obtained according to a user's request.

In addition to printing data received from the data storage device, the storage location can be obtained by another method. For example, if the storage location of the image data at the data storage device can be determined by the data input/output device in advance, the information of the storage location can be printed without receiving the storage location from the data storage device.

According to the descriptions of the invention, because the storage location of the stored image data that the user requests to have stored is printed on a print medium through a communication line, such as the Internet, the user can confirm the storage location of the image data easily. By referring to the printout, the user can acquire easily the image data by connecting to the storage device through a communication line, such as the Internet, according to the completed information.

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

The entire disclosure of Japanese Patent Application No. 2001-187406 filed on Jun. 20, 2001 including specification, claims, drawings and abstract is incorporated herein by reference in its entirety.

What claimed is:

1. An information storage method, comprising:
receiving digital data input from an input device through a communication line;
storing the received digital data; and
transmitting access information for accessing a storage location of the stored digital data and a print instruction for printing the access information to an external device having a print function through the communication line.

2. The information storage method of claim 1, wherein the access information shows the storage location where the digital data is stored.

3. The information storage method of claim 1, wherein the access information comprises identification information for permitting reference to the stored digital data.

4. The information storage method of claim 1, wherein the access information is included in each of a plurality of images on a single page, the plurality of images being defined by image data to be transmitted.

5. The information storage method of claim 1, wherein the access information is included in each of a plurality of images on a respective plurality of pages, the plurality of images being defined by image data to be transmitted.

6. An information storage method, comprising:
receiving digital data input from an input device through a communication line;
storing the received digital data; and
transmitting access information for accessing a storage location of the stored digital data and distinguishing information for identifying the digital data to an external device having a print function through the communication line.

7. The information storage method of claim 6, wherein the access information shows the storage location where the digital data is stored.

8. The information storage method of claim 6, wherein the access information comprises identification information for permitting reference to the stored digital data.

9. The information storage method of claim 6, wherein the access information is included in each of a plurality of images on a single page, the plurality of images being defined by image data to be transmitted.

10. The information storage method of claim 6, wherein the access information is included in each of a plurality of images on a respective plurality of pages, the plurality of images being defined by image data to be transmitted.

11. The information storage method of claim 6, wherein the access information and the distinguishing information are included in a composed image being defined by image data to be transmitted.

12. The information storage method of claim 6, wherein the digital data is image data and the distinguishing information is the image data having been edited.

13. The information storage method of claim 12, wherein the image data defines a plurality of images on a respective plurality of pages, and an edit of the image data is to make the image data define the plurality of images on a single page.

14. The information storage method of claim 12, wherein the edit of the image data is to include a same image in each of a plurality of locations.

15. The information storage method of claim 14, wherein the same image is included in each of a plurality of locations on a single page.

16. The information storage method of claim 14, wherein the same image is included in each of a plurality of locations on a respective plurality of pages.

17. The information storage method of claim 6, wherein the digital data is image data defining a plurality of images on a respective plurality of pages, and the distinguishing information is an image on a predetermined page among the plurality of images on the plurality of pages defined by the image data.

18. The information storage method of claim 17, wherein the image on the predetermined page is an image on the first or on the last page among the images on the plurality of pages defined by the image data.

19. An information storage method, comprising:
receiving digital data input from an input device through a communication line; storing the received digital data; and
transmitting access information for accessing a storage location of the stored digital data and advertising information to an external device having a print function through the communication line.

20. The information storage method of claim 19, wherein the access information shows the storage location where the digital data is stored.

21. The information storage method of claim 19, wherein the access information comprises identification information for permitting reference to the stored digital data.

22. The information storage method of claim 19, wherein the access information is included in each of a plurality of images on a single page, the plurality of images being defined by image data to be transmitted.

23. The information storage method of claim 19, wherein the access information is included in each of a plurality of images on a respective plurality of pages, the plurality of images being defined by image data to be transmitted.

24. The information storage method of claim 19, wherein charge information of an expense concerning the information storage can be changed.

25. A digital data processing method, comprising
inputting digital data;
transmitting the input digital data to an external device that stores the digital data through a communication line; and
printing an access information on a print medium, the access information being used for accessing the digital data that is transmitted to and stored in the external device.

26. The digital data processing method of claim 25, wherein the access information is received from the external device.

27. The digital data processing method of claim 26, wherein the input digital data is image data and at least one portion of the digital data is stored, wherein the stored digital data and the received access information are combined and printed on the print medium.

28. The digital data processing method of claim 26, wherein the input digital data is image data, and the input image data is edited and then printed on the print medium.

29. The digital data processing method of claim 25, wherein the received access information and advertising information that is stored in advance or input from the external device are printed on the print medium.

30. An information storage apparatus, comprising
a receiving device that receives digital data input from an input device through a communication line;
a storing device that stores the digital data received by the receiving device; and
a transmitting device that transmits access information for accessing a storage location that stores the digital data and a print instruction of the access information to an external device having a print function through the communication line.

31. An information storage apparatus, comprising:
a receiving device that receives digital data input from an input device through a communication line;
a storing device that stores the received digital data; and
a transmitting device that transmits access information for accessing a storage location of the stored digital data and distinguishing information for identifying the digital data to an external device having a print function through the communication line.

32. An information storage apparatus, comprising:
a receiving device that receives digital data input from an input device through a communication line;
a storing device that stores the received digital data; and
a transmitting device that transmits access information for accessing a storage location of the stored digital data and advertising information to an external device having a print function through the communication line.

33. A digital data processing apparatus, comprising
an inputting device that inputs digital data;
a transmitting device that transmits the digital data that is input from the inputting device to an external device that stores the digital data through a communication line; and a printing device that prints access information on a print medium, the access information being used for accessing the digital data that is transmitted to and stored in the external device.

34. The digital data processing apparatus of claim 33, further comprising a receiving device that receives the access information from the external device.
